(19) United States
(12) Patent Application Publication
(10) Pub. No.: US 2020/0139289 A1
(43) Pub. Date: May 7, 2020

(54) FILTER ELEMENT WITH COUNTER-FOLD, AND CASSETTE FILTER WITH SUCH FILTER ELEMENTS, AND FILTER CARTRIDGE WITH SUCH A FILTER ELEMENT

(71) Applicant: Carl Freudenberg KG, Weinheim (DE)

(72) Inventor: Renate Tapper, Bensheim (DE)

(21) Appl. No.: 16/669,612

(22) Filed: Oct. 31, 2019

(30) Foreign Application Priority Data
Nov. 5, 2018 (EP) 18 204 284.6

(51) Int. Cl. B01D 46/52; B01D 46/12; B01D 46/00

(52) U.S. Cl. CPC B01D 46/522; B01D 2265/04; B01D 46/002; B01D 46/125

(57) ABSTRACT

A filter element includes a folded filter medium. The filter medium includes two longitudinal edges and transverse edges, and a first fold. The first fold is a zigzag-shaped parallel fold in such a way that folded edges of a first type extend parallel to the transverse edges of the filter medium and folded sections of a first type are formed between fold peaks and fold troughs. The filter medium is provided with at least one second fold as a counter-fold. A folded edge of a second type is present in each folded section of a first type. Each folded edge of a second type is oriented at an obtuse angle to the folded edge of a first type in the fold trough such that triangular folded sections of a second type are formed.

### CROSS-REFERENCE TO RELATED APPLICATION

Priority is claimed to European Patent Application No. EP 18 204 284.6, which was filed on Nov. 5, 2018 and is hereby incorporated by reference herein.

### FIELD

The present invention relates to a filter element with counter-fold, to a cassette filter comprising filter elements, and to a filter cartridge comprising a filter element.

### BACKGROUND

Cassette filters are known from the prior art, for example from WO 2013/185878 A1 (see FIG. 7 therein). Cassette filters have a frame in which a plurality of filter elements is accommodated. The filter elements often consist of a pleated, that is, folded filter medium. The filter elements are accommodated in the frame in such a way that two filter elements adjoining one another are arranged at an acute angle to one another and thus have a V-shaped arrangement. Often, the flow direction of the cassette filter goes from the wide side of the V to the tip of the V. Air to be filtered then enters the filter through the opening between two filter elements. A respective V-shaped arrangement of filter elements may be referred to as a filter package. Filter elements adjoining one another are connected to one another and sealed in the boundary region, for example with the aid of cross-members filled with adhesive. No air can flow into the filter in the region of the seal. The wider the seals, the higher the pressure differential of the filter. Narrower seals, however, would have a positive effect on the pressure loss of the filter.

Filter cartridges are also known from the prior art, for example from DE 20 2016 005 074 U1. In filter cartridges, at least one filter element is mounted between a base and a cover to yield a casing comprising a filter material which encloses a volume. Cylindrical, conical or cuboid embodiments are possible, for example. An opening is provided in the region of the cover, through which the air to be filtered can escape from the filter. The greater the edge region of the cover given a predetermined external diameter, and thus the smaller the opening, the higher the pressure differential of the filter. However, the width of the edge region is limited by the height of the filter element used. The base of a cartridge may also have an opening, for example when the filter cartridge is divided in its longitudinal direction, or a seal is provided in the holding device. A wide range of filter cartridges are known from the prior art, wherein either a filter element is used, or a plurality of filter elements is also assembled.

### SUMMARY

In an embodiment, the present invention provides a filter element including a folded filter medium. The filter medium includes two longitudinal edges and transverse edges, and a first fold. The first fold is a zigzag-shaped parallel fold in such a way that folded edges of a first type extend parallel to the transverse edges of the filter medium and folded sections of a first type are formed between fold peaks and fold troughs. The filter medium is provided with at least one second fold as a counter-fold. A folded edge of a second type is present in each folded section of a first type. Each folded edge of a second type is oriented at an obtuse angle to the folded edge of a first type in the fold trough such that triangular folded sections of a second type are formed.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1a shows a filter medium according to an embodiment.

FIGS. 1b and c show the filter medium with a first fold according to an embodiment.

FIGS. 2a and b show three-dimensional views of the filter element with a fold of a second type as a counter-fold according to an embodiment.

FIGS. 3a and b show three-dimensional views of the filter element with a further fold of a second type as a counter-fold according to an embodiment.

FIG. 3c shows a view of the filter element according to an embodiment.

FIG. 4a shows a three-dimensional view of the filter element with a further counter-fold according to an embodiment.

FIG. 4b shows a view of the filter element according to an embodiment.

FIG. 5 shows a three-dimensional view of the filter element with a fold of a third type as a further counter-fold according to an embodiment.

FIG. 6a-f show different arrangement possibilities of filter elements in a cassette filter according to an embodiment.

FIG. 7 shows a filter element with a cut section according to an embodiment.

FIG. 8 shows two filter elements with an adhesive bond according to an embodiment.

FIG. 9 shows filter cartridge in accordance with the prior art according to an embodiment.

FIG. 10a shows a first embodiment of a filter cartridge.

FIG. 10b shows a second embodiment of a filter cartridge.

### DETAILED DESCRIPTION

In order to realize narrower seals (discussed above), it is known to interlock the pleated filter elements. However, there is a problem in this regard since when glass fiber paper is used as the filter medium, there is a risk of the filter medium being destroyed due to its low mechanical strength. In an alternative solution, which provides a miter cut through the filter elements, a secure sealing of the filter elements in the region of their miter can only be achieved with difficultly. A potential leakage point can easily arise here.

Embodiments of the present invention create a filter element, which contributes to reducing the pressure differential of cassette filter and filter cartridges and thus to improving filtration performance. Embodiments further provide the filter element with inherently dimensionally unstable and optionally brittle materials as well, such as, for example, glass fiber paper. Embodiments provide cassette filters and filter cartridges with improved filtration performance.

In an embodiment, one or more (e.g., all) of the above advantages are achieved through a filter element including a folded filter medium. The filter medium includes two longitudinal edges and transverse edges, and a first fold. The first fold is a zigzag-shaped parallel fold in such a way that folded edges of a first type extend parallel to the transverse edges of the filter medium and folded sections of a first type are formed between fold peaks and fold troughs. The filter medium is provided with at least one second fold as a counter-fold. A folded edge of a second type is present in each folded section of a first type. Each folded edge of a second type is oriented at an obtuse angle to the folded edge of a first type in the fold trough such that triangular folded sections of a second type are formed.

An embodiment of a filter element according to the invention has a folded filter medium, the filter medium having two longitudinal edges and two transverse edges, that is, having a length and a width, and in particular being rectangular. The filter medium has a first fold as a zigzag-shaped parallel fold. The filter medium is thus pleated. This first fold is such that folded edges of a first type extend parallel to the transverse edges of the filter medium, and folded sections of a first type are formed between fold peaks and fold troughs. In the folded product, which is produced by folding of a first type, the folded sections of a first type have four corners, two corners in each case at one end A and at the other end B of the folded section of the folded product.

The fold lengths of the first fold, i.e. the distance between fold peak and fold trough, can be uniform so that all fold lengths have the same value. Folded sections of a first type, which are the same size and are in particular rectangular, then result. Advantageously, the filter medium of the filter element can be additionally at least provided with a second fold as a counter-fold. The counter-fold can be such that a folded edge of a second type is present in the folded sections of a first type, each folded edge of a second type being oriented at an obtuse angle α to the folded edge of a first type in the fold trough. This forms folded sections of a second type, which have a triangular shape.

The height of the filter element thus produced—seen in the direction of the original longitudinal edge of the filter medium—is different at the two ends A, B of the filter element. On the side of the filter element A, on which the second fold has been introduced as a counter-fold, the filter element has a lower height. The folded edges of a second type arising from the second fold form, in particular, fold troughs, and the folded edge of a first type between two folded sections of a second type is shaped by the fold of a second type to form a fold peak in each case. In other words, a first corner of the folded section of a first type is folded in by the second fold, that is, the corner is folded over in such a way that it is laid down on the surface of the first folded section, that is to say a first corner of the folded section of a first type is folded inwards by the second folding, that is, the folded edge of a first type is folded in the opposite direction in the region of the fold of a second type.

An advantage of such a filter element is its greater stability compared to a filter element which only has folds of a first type.

The terms “fold trough” and “fold peak” should be considered as follows: The position of the observer with respect to the filter element and the observer's perspective thereof decide whether a folded edge is a fold peak or a fold trough. If, for example, the filter element is turned 180 degrees, a fold trough becomes a fold peak, and vice versa. In the previous and future use of the terms “fold peak” and “fold trough”, the terms serve to provide a clear description of an embodiment of the filter element. The intention is not to introduce a limitation to the effect that the filter element can only be visible or may only be used in a specific installation position. As such, the terms are not intended to limit the filter element to a particular orientation.

In an advantageous embodiment of the filter element according to the invention, the folded edges of a second type extend in the transverse direction of the filter medium only over a small part of the width of the filter medium, in particular over a maximum of one quarter of the width. This is particularly advantageous for the use of the filter elements in cassette filters.

When contrastingly using the filter element in a filter cartridge, however, it can be advantageous if the folded edges of a second type extend over the entire width of the filter medium, i.e., from the cover to the base of the filter cartridge. Creases of the filter element in the inner region of the filter cartridge are thus avoided.

It has been found to be advantageous to provide the filter element with a further fold of a second type, this fold being introduced into the folded section of a first type opposite the fold of a second type and dividing the height of the folded section of a first type opposite the fold of a second type. Each folded edge formed by this fold is at an obtuse angle to the folded edge of a first type in the fold peak such that triangular folded sections of a second type are formed. This fold advantageously ensures that the height of the folded filter element is reduced not only at one end A but also at the other end B. In other words, not only a first corner of the folded section of a first type but also a second corner of the folded section of a first type is folded in or folded inwards, the second corner being at the other end B of the folded section of a first type.

In an embodiment, a further counter-fold can be provided. This counter-fold is such that a further folded edge is present in each folded section of a first type, this folded edge being oriented at an obtuse angle β to the folded edge of a first type in the fold peak, so that further triangular folded sections are formed. The fold is such that the further folded edges form fold peaks, and the folded edge of a first type between two such further triangular folded sections is transformed into a fold trough. This further counter-fold divides the same longitudinal edge of the folded section of a first type, just like the fold of a second type. The filter elements folded in this way thus have a tip at the end A at which the further counter-fold is introduced. In other words, not only a first corner of the folded section of a first type but also the second corner of the folded section of a first type is folded in or folded inwards, which likewise lies at the same end A of the folded section of a first type.

In order to be able to further reduce the height of the filter element in the region of the end already provided with a counter-fold and in order to avoid a projecting of folded sections of a second type beyond the folded edges of a first type, it has been recognized as advantageous to provide the filter element with a further counter-fold, a fold of a third type. This is introduced as a counter-fold into the triangular folded sections of a second type.

It has been found to be advantageous if the filter element is cut such that the cut passes through the triangular folded sections of a second type. Edges arising in the various folds can thus be cut off in the region of the end faces of the filter elements in order to minimize an offset in height.

Embodiments of the invention also relate to a cassette filter comprising a frame and a plurality of filter elements as described above. The filter elements can be accommodated in the frame in such a way that in each case at least two filter elements adjoining one another are arranged at an acute angle ϕ to one another, wherein the folded edges of a first type of one of the adjoining filter elements each form the legs of the acute angle. The filter elements thus have a V-shaped arrangement. In an advantageous embodiment, at least every second filter element is formed within the pair of filter elements of a V-shaped arrangement as described above and has at least one counter-fold. The respective other filter element has at least one first fold, i.e. a parallel fold, as explained above.

The use of the filter elements according to the invention advantageously achieves a reduction of the areas in which no air can flow through the filter, namely the boundary regions in which the filter elements adjoin one another and are sealed. Depending on the dimensions of the filter element and the folds used, this interfering region can be significantly reduced. The reduction results in a lower pressure loss of the cassette filter and thus a better filtration performance.

In a particularly advantageous embodiment of the cassette filter according to the invention, two filter elements forming a V-shaped arrangement each have the smallest distance from one another in the region of their folded edges of a second type and/or in the region of the further folded edges. To prevent the respective filter elements from rubbing against one another and thus possibly causing destruction or at least damage to the filter medium, a minimum distance between the two filter elements can nevertheless still be provided.

It has been found to be advantageous if the folded edges of a second type of two filter elements adjoining one another in each case are at a minimal distance apart, in particular a maximum of three millimeters. This enables a particularly narrow arrangement of the filter elements, the filter elements nevertheless not interfering with one another. In this case, adjoining each other does not necessarily mean touching each other, but rather to be positioned directly next to one another.

In an alternative embodiment, the folded edges of a second type of two filter elements adjoining one another in each case, which form a V-shaped arrangement, are positioned at such a small distance from one another that they touch one another. Such an arrangement is recommended primarily when the filter medium is tolerant to contact. An example of a suitable filter medium for this purpose is made of polypropylene.

In a particularly advantageous embodiment of the cassette filter, two filter elements adjoining each other are glued indirectly or directly to one another. In the case of an indirect adhesive bond, a cross-member can be provided into which an adhesive is introduced. In the case of a direct adhesive bond, no further elements are required, the adhesive is applied directly to the filter elements, and they are directly connected to one another. The adhesive bond extends in particular only on the end faces of the filter elements. The effective filter surface thus remains virtually unchanged, and the filtration performance is hardly impaired. The adhesive bond, in particular with cross-members of the frame, ensures that there are no leakage points between the filter elements and the air to be filtered, not without experiencing any filtration through the filter medium, can flow through the filter through the leakage points. It is considered advantageous to realize the adhesive bond by means of cast PUR.

An embodiment of the invention also relates to a filter cartridge having a base, a cover provided with a central recess, and at least one filter element arranged between the base and the cover. The filter element is designed as described above and thus has a filter medium provided with a fold and a counter-fold. The filter element is shaped in such a way that a casing comprising a filter material is produced which encloses a volume. Cylindrical, conical or cuboid embodiments are possible, for example. For example, the filter element may be rolled into a cylindrical or frustoconical shape, so that a cylindrical or frustoconical filter cartridge is formed. The at least one counter-fold of the filter element is advantageously oriented towards the recess of the cover. That end of the filter element into which the at least one counter-fold is inserted thus adjoins the cover. The use of a counter-folded filter element advantageously enables a larger recess in the cover, that is, a hole with a larger diameter. The pressure loss of the filter cartridge can thus be substantially reduced, and the filtration performance of the filter cartridge increased.

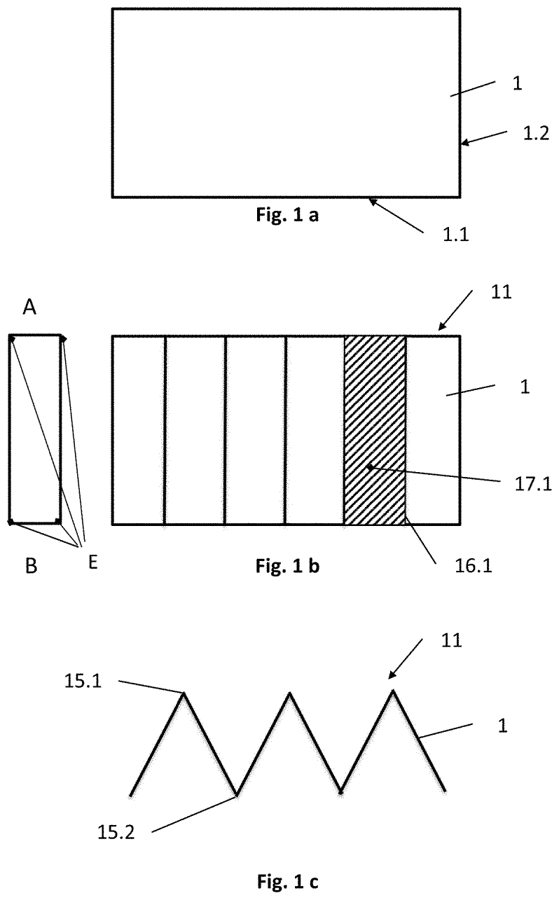

FIG. 1a shows a rectangular filter medium 1 having a shorter transverse edge 1.2 and a longer longitudinal edge 1.1. This filter medium receives a first fold 11, that is, a parallel fold, which is also referred to as Leporello folding. The filter medium 1 is thus pleated. The fold of a first type 11 is shown in FIGS. 1b and 1c.

As shown in FIG. 1b, folded edges of a first type 16.1 located parallel to one another are produced by the first fold 11 and folded sections of a first type 17.1, which are each delimited by two folded edges of a first type 16.1 or by a folded edge of a first type 16.1 and the transverse edge 1.2. In order to clarify the position of a folded section of a first type 17.1, the folded section 17.1 is shown hatched.

Fold peaks 15.1 and fold troughs 15.2 arise by the fold of a first type 11, as shown in FIG. 1c. In the folded product which is produced by the fold of a first type 11, the folded sections of a first type 17.1 have four corners, two corners respectively at one end A and at the other end B of the folded section 17.1 of the folded product. The corners E are shown in FIG. 1b on the left in the side view of the folding product.

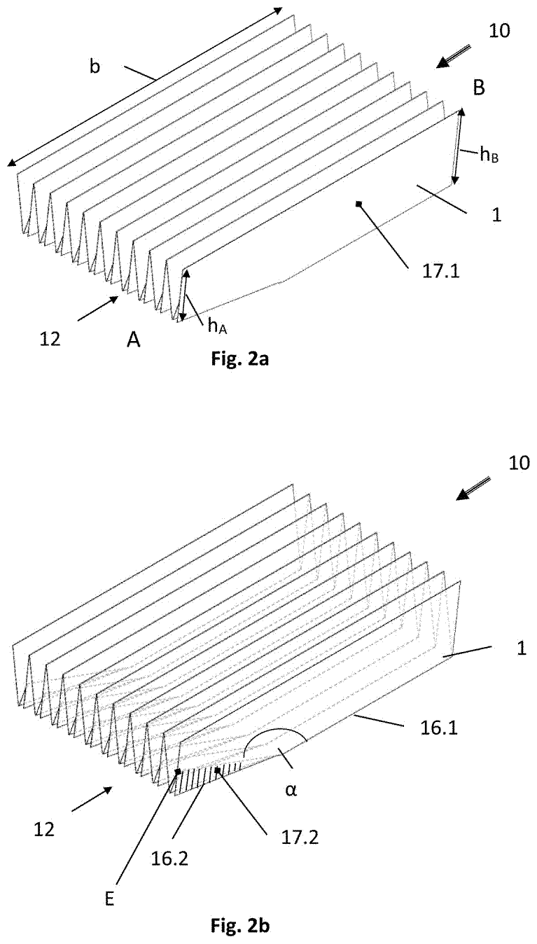

According to an embodiment of the invention, a filter medium 1 provided with such a first fold 11 is further processed by at least one further fold 12. Different variants of a filter element 10 according to the invention having a first fold 11 and at least one further fold 12, 13, 14 are depicted in FIG. 2-5, described below.

In the filter element 10 shown in FIGS. 2a and b, the filter medium 1 is provided at the end A of the folded section of a first type 17.1 with a second fold 12 as a counter-fold. In so doing, a folded edge of a second type 16.2 was produced in each folded section of a first type 17.1, wherein the fold 12 is such that each folded edge of a second type 16.2 is oriented at an obtuse angle α to the folded edge of a first type 16.1 in the fold trough 15.2 (see FIG. 2b).

The second fold 12 forms folded sections of a second type which have a triangular shape 17.2. In order to clarify the position of a triangular folded section of a second type 17.2, it is shown hatched. The second fold 12 and folded edges of a second type 16.2 extend only over a small part of the width b of the filter medium 1 in the design variant shown in FIGS. 2a and 2b. In other words, a first corner E of the folded section of a first type 17.1 is folded in or folded inwards by the second fold 12, that is, the corner E is folded over in such a way that it is laid down on the surface of the first folded section 17.1.

The second fold 12 results in the filter element 10 having a lower height hA in the region of the second fold 12 at the end A than the height hB at the end B of the filter element 10.

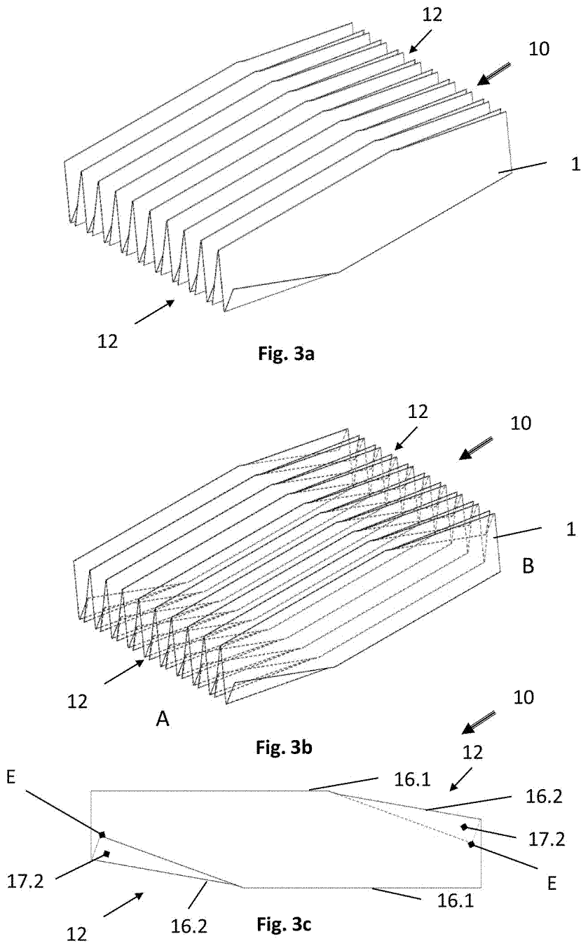

The filter element 10 shown in FIGS. 3a-3c has, in addition to the fold of a second type 12, as shown in FIG. 2, been provided with a further fold of a second type 12, this fold 12 of a second type being inserted obliquely with respect to the fold of a second type 12 into the folded section of a first type 17.1 at the other end B of said folded section 17.1. This further fold 12 of a second type is to be seen on the right side in FIG. 3a.

This further fold of a second type 12 and its folded edge of a second type 16.2 divides the longitudinal edge of the folded section of a first type 17.1 opposite the fold of a second type described with reference to FIGS. 2a and 2b. In other words, not only a first corner E of the folded section of a first type 17.1 but also an opposite second corner E of the folded section of a first type 17.1 is folded in or folded inwards, the second corner E being at the other end B of the folded section of a first type 17.1. Triangular folded sections of a second type 17.2 are also formed by this further fold of a second type 12. As can be seen particularly well from the side view of FIG. 3c, the filter element 10 has a lower height in the region of the two folds of a second type 12.

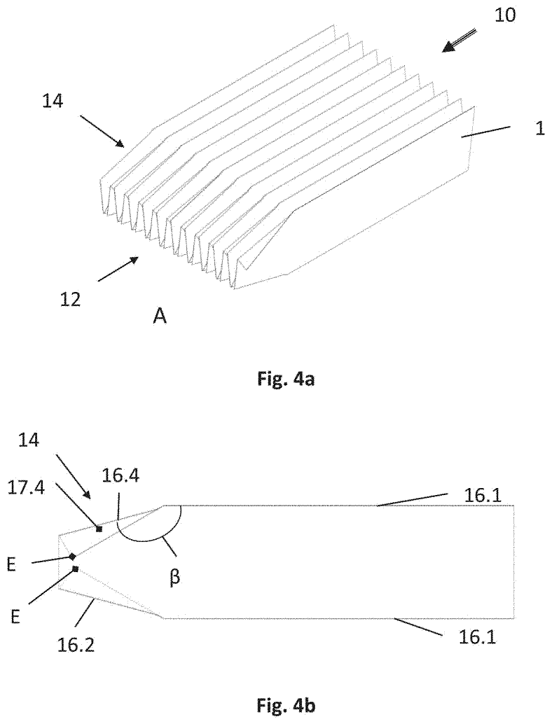

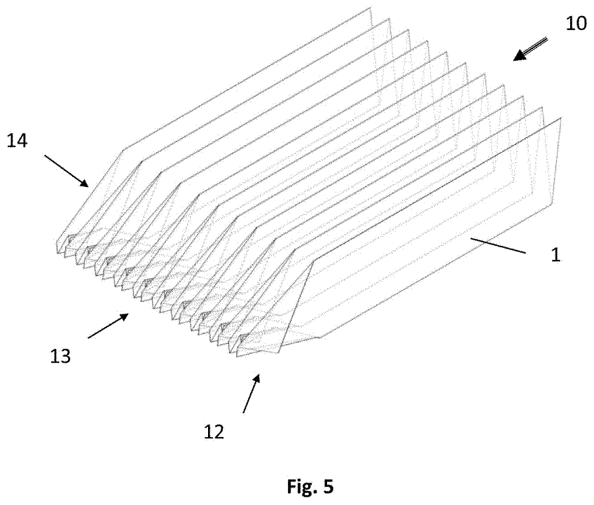

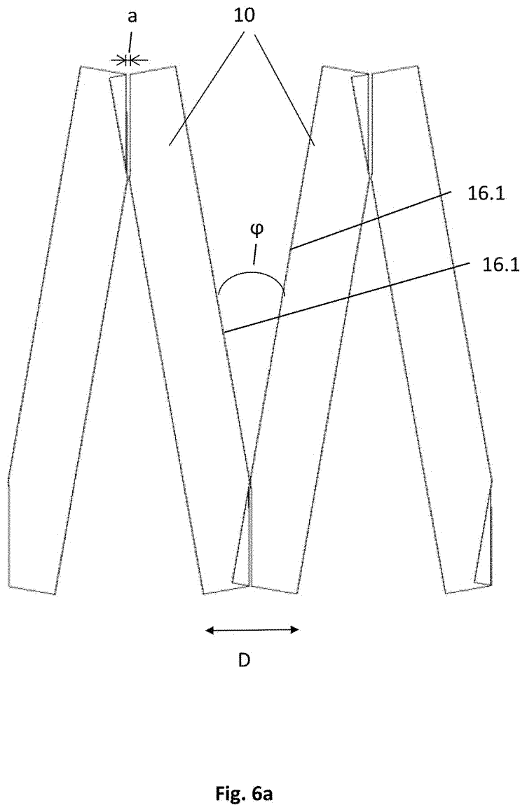

The filter element 10 shown in FIGS. 4a and 4b was provided with a further counter-fold 14 starting from the filter element 10, as shown in FIGS. 2a and 2b. The further counter-fold 14 is in this case such that a further fold edge 16.4 is present, said fold edge 16.4 being oriented at an obtuse angle β to the folded edge of a first type 16.1 in the fold peak 15.1. In other words, not only a first corner E of the folded section 17.1 of a first type but also the second corner E of the folded section 17.1 of a first type is folded in or folded inwards, which is likewise at the same end A of the folded section of a first type 17.1.

Further triangular folded sections 17.4 thus ensue by means of the further counter-fold 14. In the region of the filter element 10, in which the filter medium 1 is provided with the second fold 12 and the further counter-fold 14, the filter element 10 is designed pointed in its side view with a tapered height.

In addition to the filter element 10 shown in FIG. 5, the filter medium 1 has additionally been provided with a fold of a third type 13 which is introduced as a counter-fold 13 into the triangular folded sections of a second type 17.2. Due to the second fold 12, the third fold 13 and the further counter-fold 14, all of which are introduced in a region of the filter element 10, the height of the filter element 10 can be greatly reduced in this region.

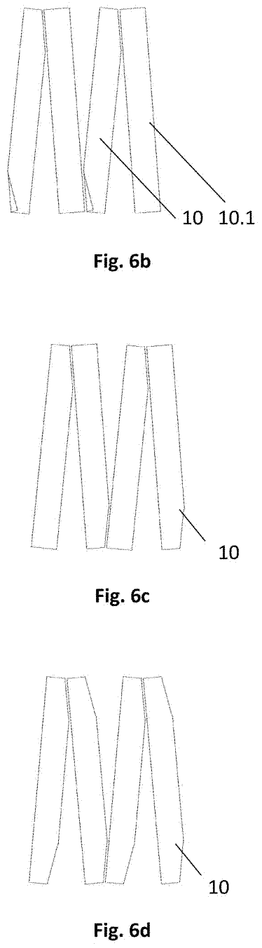

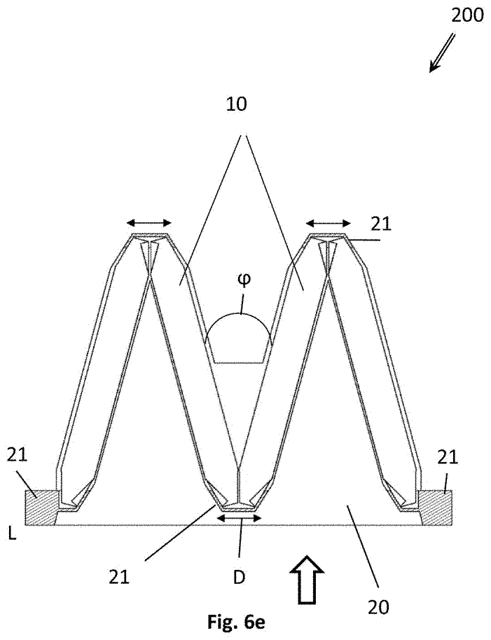

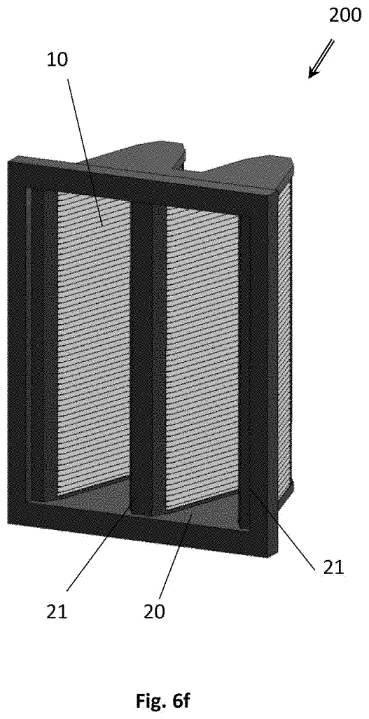

FIG. 6a illustrates how the embodiments of the filter elements 10 described above can be positioned with respect to one another as a function of the folds 12, 13, 14 present, so that the filter elements 10 are arranged at an acute angle ϕ to one another and can be accommodated by a frame of a cassette filter 200 (see FIG. 60. The folded edges of a first type 16.1 of two adjoining filter elements 10 form the legs of the acute angle ϕ. As a result, the filter elements 10 have a V-shaped arrangement.

In the variant shown in FIG. 6a, filter elements 10 have been used which are each provided with a second fold 12 as a counter-fold and an opposite further second counter-fold 12. By using these filter elements 10, in contrast to filter elements which are not provided with counter-folds 12, 13, 14 and have a rectangular design in their side view, the region D can be reduced, wherein the region D is that which lies in the boundary region and air L cannot flow thorough because of the sealing of the filter elements. By reducing this area D, the sealed no-flow area can be reduced, and the pressure differential of a filter 200 with such filter elements 10 reduced.

In an embodiment, to prevent the filter elements 10 from rubbing against one another and damage to the filter medium 1, the filter elements 10 are at a distance a from one another. This distance can be in the range of a few millimeters.

In the arrangement variant depicted via the embodiment of FIG. 6b, filter elements 10 with a counter-fold 12 and filter elements 10.1 without such a counter-fold were used alternately.

In the arrangement variant depicted via the embodiment of FIG. 6c, filter elements 10 with only one counter-fold 12 were used.

In the arrangement variant depicted via the embodiment of FIG. 6d, filter elements 10 were used which are each provided with two counter-folds 12, that is, in each case one counter-fold 12 at the respective end of the filter medium 1.

In the arrangement variant depicted via the embodiment of FIG. 6e, filter elements 10 were used which are provided with a plurality of counter-folds 12, 13, 14. The filter elements 10 are thus designed to be particularly narrow at their respective ends, i.e. have a low height.

In the boundary region, where the filter elements 10 adjoin one another and are sealed against one another, strip-shaped cross-members 21 are provided in this example. In order to seal the filter elements 10 with respect to the frame 20 and the cross-members 21 and for there to be no by-passes where air L can pass through the filter 200 without passing through the filter elements 10, the filter elements 10 can be glued together in the region of the cross-member 21.

Such an adhesive bond V which can be created, for example, by a casting with PUR adhesive, is indicated in FIG. 8. The cross-members 21 can likewise have a narrow design. As a result, the region D through which air L cannot flow can be kept small. In the sectional view of FIG. 6e, the cross-members 21 are shown hatched. The filter elements 10 are received by a frame 20 and thus form a cassette filter 200 with a V-shaped arrangement of the filter elements 10.

FIG. 6f shows by way of example a cassette filter 200 with the embodiment of the filter elements 10 according to FIG. 6e. The filter elements 10 are arranged in a frame 20 in such a way that a V-shaped arrangement of the filter elements 10 results.

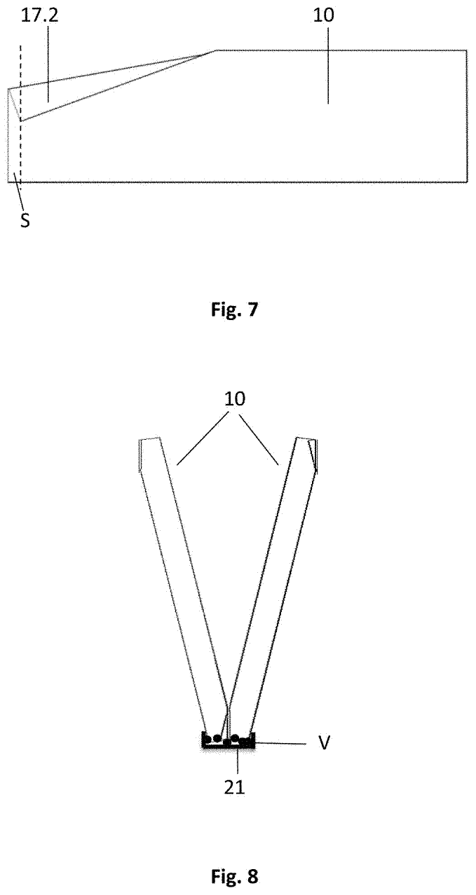

In order to simplify the adhesive bond V and reduce the need for adhesive, the height offset in the region of the counter-folds 12, 13, 14 can be minimized in which a cut section S is created by the folded section of a second type 17.2. This is shown in FIG. 7.

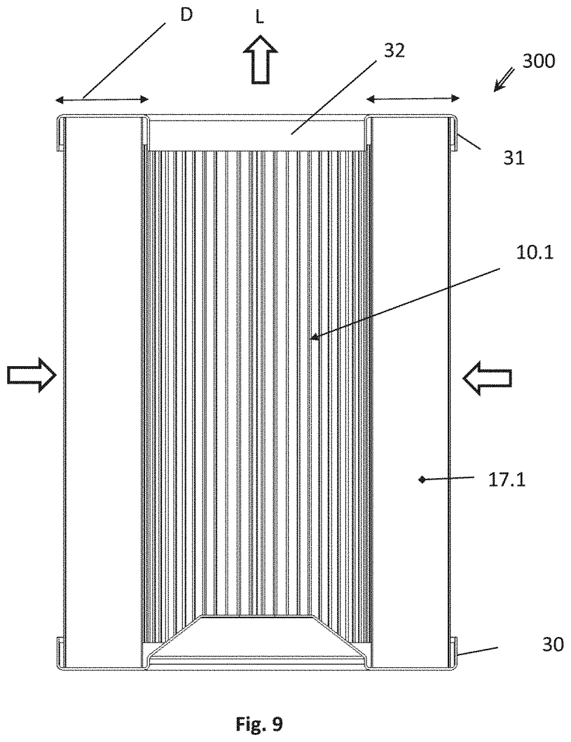

In FIG. 9, a prior art filter cartridge 300 is shown in cross-section. The filter cartridge 300 has a base 30, a cover 31 provided with a central recess 32 and a filter element 10.1 arranged between the cover 31 and the base 30, the filter element 10.1 being brought into a cylindrical shape. The filter element 10.1 was provided with a fold of a first type 11 and is thus pleated.

The air L to be filtered can escape from the filter 300 through the recess, that is, the opening 32 in the cover 31. The larger the edge region of the cover 31, and thus the smaller the opening 32, the higher the pressure differential of the filter 300. However, the width D of the edge region is limited by the height of the filter element 10.1 used, that is to say the fold height of the filter element 10.1 used, that is to say the height of the folded section of a first type 17.1.

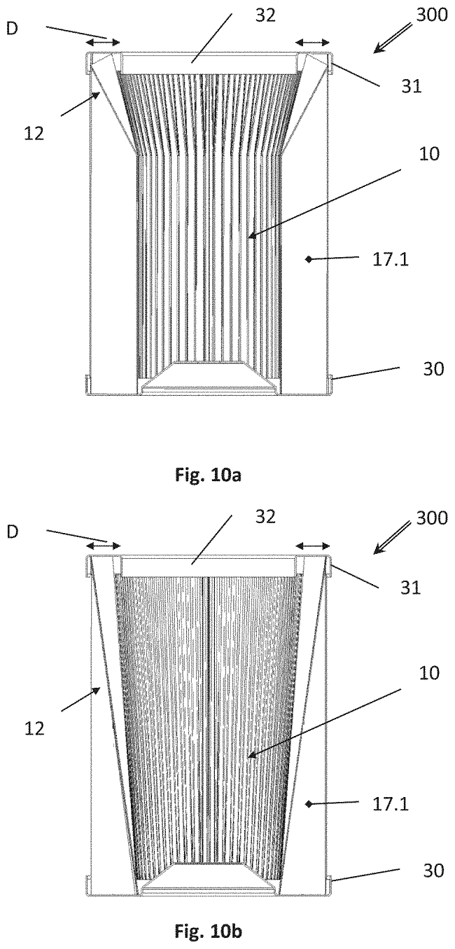

Filter cartridges 300 are also shown in FIGS. 10a and 10b. In contrast to the filter cartridge 300 according to the prior art, however, a filter element 10 with a counter-fold 12 was used in these filter cartridges according to an embodiment of the invention. A plurality of counter-folds 12, 13, 14, as described above could also be provided. The counter-fold 12 of the filter element 10 is oriented towards the recess 32 such that the filter element 10 has a lower height in the region of the cover 31 so that the edge region of the cover 31 can be smaller, and the diameter of the recess 32 can be larger. In other words, the region D through which air cannot flow can be reduced.

While the counter-fold 12 and thus the folded edges of a second type 16.2 according to FIG. 10a extend only over a small part of the width of the filter element 10, according to FIG. 10b they extend over the entire width. In the second variant, a continuous change in the height of the filter element and thus a continuous widening of the interior of the filter cartridge 300 result, that is, there are no creases in the filter element 10.

### LIST OF REFERENCE SIGNS

1 Filter medium
1.1 Longitudinal edge
1.2 Transverse edge
10 Filter element
10.1 Filter element without counter-fold
11 First fold/fold of a first type
12 Second fold/fold of a second type
13 Third fold/fold of a third type
14 Further fold/fold of a further type
15.1 Fold peak
15.2 Fold trough
16.1 Folded edge of a first type
16.2 Folded edge of a second type
16.3 Folded edge of a third type
16.4 Folded edge of a further type
17.1 Folded section of a first type
17.2 Folded section of a second type
17.3 Folded section of a third type
17.4 Folded section of a further type
20 Frame
21 Cross-member
30 Base
31 Cover
32 Recess (hole)
200 Cassette filter
300 Filter cartridge
a Distance
b Width of the filter medium
A End of the folded product
B Other end of the folded product
D Region through which air cannot flow
E Corner of the folded product
L Air flow
S Cut section
V Adhesive bond
α Angle between the folded edge of a first type and of a second type
β Angle between the further folded edge and folded edge of a first type
ϕ Angle between adjacent filter elements

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A filter element comprising a folded filter medium, the filter medium comprising:
two longitudinal edges and transverse edges; and
a first fold as a zigzag-shaped parallel fold in such a way that folded edges of a first type extend parallel to the transverse edges of the filter medium and folded sections of a first type are formed between fold peaks and fold troughs;
wherein the filter medium is provided with at least one second fold as a counter-fold, wherein a folded edge of a second type is present in each folded section of a first type, wherein each folded edge of a second type is oriented at an obtuse angle to the folded edge of a first type in the fold trough such that triangular folded sections of a second type are formed.

2. The filter element according to claim 1, wherein the folded edges of a second type form fold troughs and the folded edge of a first type present between two folded sections of a second type forms a fold peak.

3. The filter element according to claim 1, wherein the folded edges of a second type only extend over a small part of the width of the filter medium, in particular over a maximum of one quarter of the width.

4. The filter element according to claim 1, wherein the filter medium is provided with at least one further second fold as a counter-fold, wherein the fold folds in or folds inwards at least one further corner of the folded section of a first type, wherein the further corner is located at the same end and/or at the other end of the folded section of a first type in which the second fold is introduced as a counter-fold.

5. The filter element according claim 1, wherein the filter medium is provided with a further fold of a second type, the fold being introduced into the folded section of a first type opposite the fold of a second type, and dividing the height of the folded section of a first type opposite the fold of a second type.

6. The filter element according to claim 1, wherein the filter medium is provided with a further counter-fold, wherein a further folded edge is present in each folded section of a first type, the folded edge being oriented at an obtuse angle to the folded edge of a first type located in the fold peak such that further triangular folded sections are formed.

7. The filter element according to claim 1, wherein the filter medium is provided with a fold of a third type which is introduced as a counter-fold into the triangular folded sections of a second type.

8. The filter element according to claim 1, wherein the filter element is cut such that the cut passes through the triangular folded sections of a second type.

9. A cassette filter comprising:
a frame; and
a plurality of filter elements with a filter medium provided with a fold, wherein the filter elements are accommodated in the frame in such a way that at least two adjoining filter elements are arranged at an acute angle to each other and thus possess a V-shaped arrangement;
wherein at least every second filter element is designed according to the filter element of claim 1.

10. The cassette filter according to claim 7, configured such that in each case, two filter elements forming a V-shaped arrangement are at the smallest distance from each other in the region of folded edges of a second type.

11. The cassette filter according to claim 8, configured such that the folded edges of a second type of two filter elements adjoining each other in each case are at a minimal distance apart, in particular a maximum of 3 mm.

12. The cassette filter according to claim 8, configured such that the folded edges of a second type of two filter elements each adjoining one another touch each other.

13. The device according to claim 7, configured such that two adjoining filter elements each are glued to one another.

14. A filter cartridge comprising:
a base,
a cover provided with a central recess, and
at least one filter element arranged between the cover and the base, wherein the filter element is designed according to the filter element of claim 1 and the counter-fold of the filter element is oriented towards the recess.
